(19) United States
(12) Patent Application Publication
(10) Pub. No.: US 2024/0421860 A1
(43) Pub. Date: Dec. 19, 2024

(54) TERMINAL AND SENDING DEVICE IN COMMUNICATION SYSTEM

(71) Applicant: NTT DOCOMO, INC., Tokyo (JP)

(72) Inventors: Fan Wang, Beijing (CN); Xin Wang, Beijing (CN); Xiang Li, Beijing (CN); Xiaolin Hou, Beijing (CN); Lan Chen, Beijing (CN); Satoshi Suyama, Tokyo (JP); Tatsuki Okuyama, Tokyo (JP)

(73) Assignee: NTT DOCOMO, INC., Tokyo (JP)

(21) Appl. No.: 18/707,021

(22) PCT Filed: Nov. 24, 2021
(86) PCT No.: PCT/CN2021/132925

§ 371 Date: May 2, 2024

(51) Int. Cl. H04B 7/04; H04L 5/00; H04W 64/00

(52) U.S. Cl. CPC H04B 7/04026; H04L 5/0051; H04W 64/00

(57) ABSTRACT

Provided in the present disclosure are a terminal and a sending device in a communication system. The sending device includes: a receiving unit, which is configured to receive position information of a terminal, and a control unit, which is configured to determine a first codeword in a first codebook and offset information according to the position information. The first codeword indicates initial phases of at least some array elements in a reconfigurable intelligent surface (RIS). The offset information indicates an offset relative to the at least one of the at least some array elements, the initial phases, and a reference position of the RIS.

### TECHNICAL FIELD

The present disclosure relates to the field of wireless communications, and more particularly to a method performed by a terminal in a communication system, a method performed by a sending device in the communication system, and a corresponding terminal and sending device.

### BACKGROUND

Reconfigurable Intelligent Surface (RIS) is an artificial electromagnetic surface structure with programmable electromagnetic properties. RIS is intended to serve as a reconfigurable space electromagnetic wave regulator to intelligently reconstruct the wireless propagation environment between transceivers in communication systems. RIS can be combined with multi-antenna technology such as Multiple Input Multiple Output (MIMO) technology, and by introducing a certain phase shift to RIS, focused beam transmission in any direction in space can be achieved. The RIS structure is relatively simple and easy to manufacture, and is a feasible technology for realizing large-scale radiation arrays in 5G New Radio (NR) and subsequent wireless communication network systems.

5G NR and its subsequent wireless communication network systems further put forward the requirements for ultra-high speed, large-capacity communication, low power consumption, and low cost. In order to achieve ultra-high-speed and large-capacity communication requirements, wireless communication network systems need to further increase the operating frequency band, such as reaching terahertz (THz), and further improve the signal-to-noise ratio (SNR), and higher SNR requires greater scale radiating array. As the working frequency band of the wireless communication network system increases and the scale of the radiation array increases, the near-field radiation range of the radiation array also increases. For RIS, higher RIS matching accuracy will increase power consumption and cost. In order to meet the needs of low power consumption and low cost, lower phase configuration (hereinafter referred to as “matching”) accuracy of the radiation array elements is required, such as 1 bit or 2 bits.

On the other hand, in scenarios where multi-antenna technology is applied, in order to effectively eliminate multi-user interference, improve system capacity, and reduce the signal processing difficulty of the receiver, it is proposed to apply precoding/beamforming on the transmitter side. The precoding technology can adopt codebook-based precoding, that is, the transmitter side and the receiver side share a known codebook set, and the codebook set contains multiple precoding matrices. The codebook in the existing precoding technology uses a codebook based on a Discrete Fourier Transform (DFT) matrix (hereinafter referred to as the DFT codebook). However, when the DFT codebook is used for beamforming or precoding within the near-field radiation range of the RIS, there will be a large SNR loss, and when the RIS adopts low phase shift accuracy, such as 1-bit DFT codebook, for beamforming or precoding, periodic quantization errors will be caused, which will increase the side lobe level of the radiation array or produce mirror-image grating lobes with the same power as the main lobe, which may cause interference to other receivers.

### SUMMARY OF THE DISCLOSURE

In order to overcome the defects in the prior art, the present disclosure proposes a codebook structure suitable for RIS, thereby improving the performance of the communication system. The present disclosure also proposes that in this case, the method performed by the terminal, the method performed by the base station, and the corresponding terminal and base station effectively carry out codebook design suitable for RIS to improve SNR of near-field radiation range of the radiation array and reduce electromagnetic signal leakage caused by the grating lobes and side lobes of the radiation array, thereby further improving performance of the communication system.

According to an aspect of the present disclosure, a method performed by a sending device in a communication system is provided, including: receiving position information of a terminal; and determining a first codeword in a first codebook and offset information according to the position information, wherein the first codeword indicates initial phases of at least some array elements of a Reconfigurable Intelligent Surface (RIS), and the offset information indicates an offset relative to at least one of the at least some array element, the initial phases, and a reference position of the RIS.

According to an example of the present disclosure, wherein the position information includes information about the distance between the RIS and the terminal, and information about the angle of the terminal relative to the RIS, the method further includes: determining radii of a plurality of wave bands generated by the RIS based on the information about the distance, and determine the first codeword based on the determined radii; and determining the offset information based on the information about the angle.

According to an example of the present disclosure, the offset information includes a second codeword in a second codebook.

According to an example of the present disclosure, the second codebook is a DFT Discrete Fourier Transform (DFT) codebook, and the offset information indicates an offset relative to the initial phases.

According to an example of the present disclosure, the offset information includes an offset relative to at least some array elements.

According to an example of the present disclosure, the sending device is a base station in the communication system, and the base station includes the RIS.

According to an example of the present disclosure, the sending device is a Smart Repeater in the communication system, and the Smart Repeater includes the RIS.

According to another aspect of the present disclosure, a method performed by a terminal in a communication system is provided, including: obtaining position information of the terminal; sending the position information of the terminal, wherein the position information includes information about a distance between a Reconfigurable Intelligent Surface (RIS) and the terminal, and information about an angle of the terminal relative to the terminal.

According to an example of the present disclosure, the method further includes: sending a distance indication or a near-field condition indication to a sending device, wherein the distance indication or the near-field condition indication includes the position information.

According to an example of the present disclosure, the method further includes: obtaining the position information based on a channel state information reference signal or a positioning reference signal.

According to another aspect of the present disclosure, a sending device is provided, including: a receiving unit configured to receive position information of a terminal; and a control unit configured to determine a first codeword in a first codebook and offset information according to the position information, wherein the first codeword indicates initial phases of at least some array elements of a Reconfigurable Intelligent Surface (RIS), and the offset information indicates an offset relative to at least one of the at least some array element, the initial phases, and a reference position of the RIS.

According to an example of the present disclosure, the position information includes information about the distance between the RIS and the terminal, and information about the angle of the terminal relative to the RIS; the control unit is further configured to determine radii of a plurality of wave bands generated by the RIS based on information about distance, and determine the first codeword based on the determined radii; and the control unit is further configured to determine the offset information based on information about the angle.

According to an example of the present disclosure, the offset information includes a second codeword in a second codebook.

According to an example of the present disclosure, the second codebook is a DFT codebook, and the offset information indicates an offset relative to the initial phase.

According to an example of the present disclosure, the offset information includes an offset relative to at least some array elements.

According to an example of the present disclosure, the sending device is a base station in the communication system, and the base station includes the RIS.

According to an example of the present disclosure, the sending device is a Smart Repeater in the communication system, and the Smart Repeater includes the RIS.

According to another aspect of the present disclosure, a terminal is provided, including: a control unit to obtain position information of the terminal; and a sending unit to send the position information of the terminal, wherein the position information includes information about a distance between a Reconfigurable Intelligent Surface (RIS) and the terminal, and information about an angle of the terminal relative to the terminal.

According to an example of the present disclosure, the sending unit is further configured to send a distance indication or a near-field condition indication to a sending device, wherein the distance indication or the near-field condition indication includes the position information.

According to an example of the present disclosure, the control unit is further configured to obtain the position information based on a channel state information reference signal or a positioning reference signal.

According to the method performed by the terminal, the method performed by the sending device, and the corresponding terminal and sending device according to the above aspects of the present disclosure, codebook design suitable for RIS can be effectively performed, thereby improving performance of the communication system.

### BRIEF DESCRIPTION OF THE DRAWINGS

The above and other objects, features and advantages of the present disclosure will become more apparent through a more detailed description of the embodiments of the present disclosure in conjunction with the accompanying drawings. The drawings are used to provide further understanding of the embodiments of the present disclosure, and constitute a part of the specification. They are used to explain the disclosure together with the embodiments of the present disclosure, and do not constitute a limitation of the disclosure. In the drawings, like reference numbers generally refer to like components or steps.

FIGS. 1a and 1b illustrate schematic embodiments of a RIS-based sending device architecture in which embodiments of the present disclosure may be applied.

FIG. 2 illustrates a schematic diagram of a wireless communication system in which embodiments of the present disclosure may be applied.

FIG. 3 illustrates a method performed by a sending device according to embodiments of the present disclosure.

FIG. 4a illustrates some representations of position information of a terminal according to embodiments of the present disclosure.

FIG. 4b illustrates some other representations of position information of the terminal according to embodiments of the present disclosure.

FIGS. 5a and 5b illustrate an example of determining the first codeword in the first codebook according to the position information in the embodiment of the present disclosure.

FIG. 6 illustrates a focused beam formed according to the first codeword of the first codebook in embodiments of the present disclosure.

FIGS. 7a-7f illustrate examples of determining offset information based on position information in embodiments of the present disclosure.

FIGS. 8a and 8b illustrate examples of wireless communication systems used to deploy RIS according to embodiments of the present disclosure.

FIG. 9 illustrates a method performed by a terminal according to embodiments of the present disclosure.

FIG. 10 illustrates a schematic structural diagram of a sending device according to embodiments of the present disclosure.

FIG. 11 illustrates a schematic structural diagram of a terminal according to embodiments of the present disclosure.

FIG. 12 is a schematic diagram of the hardware structure of a communication device according to embodiments of the present disclosure.

### DESCRIPTION OF THE EMBODIMENTS

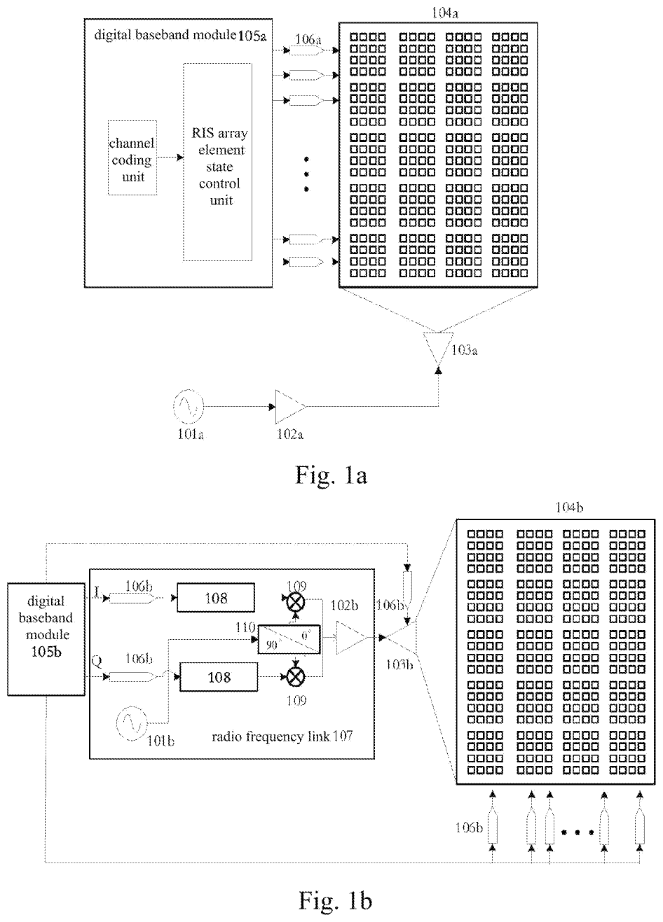

In order to make the objects, technical solutions and advantages of the present disclosure more apparent, example embodiments according to the present disclosure will be described in detail below with reference to the accompanying drawings. In the drawings, like reference numbers refer to like elements throughout. It should be understood that the embodiments described herein are illustrative only and should not be construed as limiting the scope of the present disclosure. Embodiments based on sending device architectures with different RIS configurations in which embodiments of the present disclosure may be applied are described below with reference to FIGS. 1a and 1b.

FIG. 1a is an embodiment of a sending device architecture based on a RIS configuration. In the example of FIG. 1a, the adjustment of the phase of RIS 104a may be accomplished by digital baseband module 105a. As shown in FIG. 1a, the RIS-based sending device architecture includes a carrier source 101a, a power amplifier 102a, a feed antenna 103a, a RIS 104a, a digital baseband 105a and a plurality of digital-to-analog converters 106a. The single-tone carrier signal generated by the feed antenna 103a is irradiated on the RIS 104a, and the RIS 104a dynamically regulates the parameters of the reflected electromagnetic wave under the control of the external baseband signal, thereby modulating the information on the electromagnetic wave. The external baseband signal for the RIS 104a can be generated through the channel coding unit and the RIS array element state control unit in the digital baseband 105a and the corresponding digital-to-analog converter 106a.

In addition, the working area of the RIS can be adjusted through the digital baseband module. FIG. 1b shows another embodiment of a sending device architecture based on another RIS configuration. As shown in FIG. 1b, the RIS-based sending device architecture includes a digital baseband 105b, a radio frequency link 107, a feed antenna 103b, a RIS 104b and a plurality of digital-to-analog converters 106b. Radio frequency link 107 includes a carrier source 101b, a plurality of filters 108, a plurality of mixers 107, a phase modulator 110 and a power amplifier 102b. The modulated signal generated by the digital baseband 105b is up-converted to the working frequency band through the radio frequency link and then transmitted to the feed antenna 103b. It is radiated to the RIS 104b through the feed antenna 103b, and the RIS 104b implements beam forming through array element phase transformation. In this example, the status control signals for RIS 104b are generated by digital baseband 105b and corresponding plurality of digital-to-analog converters 106b. In the example of FIG. 1b, the phase of the RIS 104b can be adjusted through the digital baseband module 105b, and the working area of the RIS 104b can also be adjusted through the digital baseband module 105b. As shown by the dotted line in FIG. 1b, the digital baseband module 105b can generate a control signal for adjusting the working mode of the feed antenna 103b, which can adjust the position of some array elements radiated by the feed antenna 103b to the RIS 104b. In one example, the feed antenna 103b is a single antenna installed on a mechanical scanning frame, and the control signal adjusts the position of the feed antenna 103b radiated to some array elements in the RIS 104b by controlling the direction of the scanning frame. In another example, the feed antenna 103b has a phased array structure, and the control signal adjusts the direction of the radiation beam by controlling the phase of each element of the phased array, thereby adjusting the position of a portion of the array elements radiated by the feed antenna 103b to the middle part of the RIS 104b.

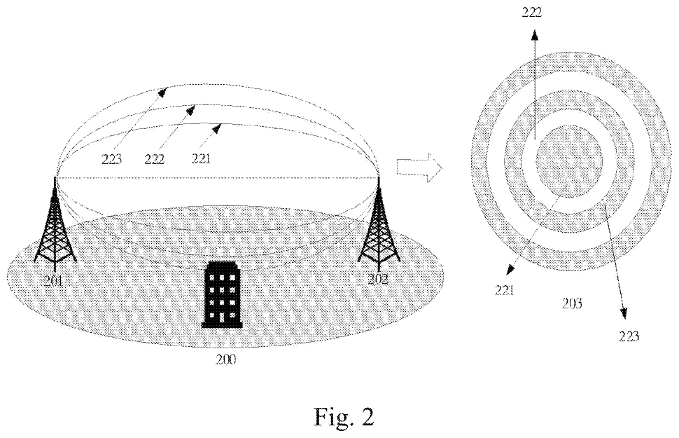

Next, a schematic diagram of a wireless communication system in which embodiments of the present disclosure may be applied is described with reference to FIG. 2. The wireless communication system 200 shown in FIG. 2 may be a 5G communication system, or any other type of wireless communication system, such as a 6G communication system, etc. In the following, embodiments of the present disclosure are described taking a 5G communication system as an example, but it should be appreciated that the following description may also be applied to other types of wireless communication systems.

As shown in FIG. 2, the wireless communication system 200 may include a sending device 201 and a receiving device 202, where the sending device 201 may include an RIS. Based on the Fresnel diffraction principle, according to the predetermined position of the receiving device 202, the array elements in the sending device 201 may be divided into the first wave band area 221, the second wave band area 222, the third wave band area 223, . . . , the Nth wave band area, so that by setting the phase of the array elements in each wave band, the beams emitted by each wave band area can focusing on the receiving device 202, where Nis an integer greater than one. The vertical cross-sections of these N waveband areas are concentric rings as shown at 203 in FIG. 2. According to an example of the present disclosure, odd-numbered waveband areas, such as the first waveband area 221, the third waveband area 223, etc. in FIG. 2, are in positive phase superlocation at the receiving device 202, increasing the field strength, and the RIS can be phase-shifted by 0°, which corresponds to the gray area in 203 in FIG. 2; even-numbered waveband areas such as the second waveband area 222 in FIG. 2 have anti-phase superlocation at the receiving device 202, reducing the field strength, and the RIS can shift the phase 180°, which corresponds to the white area in 203 of FIG. 2.

The receiving device described here may include various types of terminals, such as user equipment (UE), mobile terminals (also known as mobile stations), or fixed terminals. However, for convenience, terminals and UEs are sometimes interchangeably used hereinafter.

The sending devices described herein may include base stations that may provide communication coverage for a specific geographical area, which may be referred to as cells, NodeBs, gNBs, 5G NodeBs, access points, and/or transmitting and receiving points, etc. The sending device described here may also include a Smart Repeater (SR).

It should be understood that although FIG. 2 only shows one sending device and one receiving device, the wireless communication system may include more sending devices and/or more receiving devices, and one sending device may serve multiple receiving devices, one receiving device can also be served by multiple sending devices.

However, in the process of the sending device determining the focusing matching scheme of the RIS based on the Fresnel diffraction principle described above, since the RIS is required to be located on the connection between the sending device and the receiving device 202 and perpendicular to the connection, and the wave band area on RIS is required to be set according to the distance between the sending device and the receiving device and matched, the determined focusing and matching scheme of the RIS is fixed, and the sending device cannot focus the transmit signal on any point in space.

In addition, under near-field conditions formed by large-scale RIS, when beamforming is performed using precoding technology based on existing codebooks, the beamforming gain will exhibit “fluctuation” characteristics, which has a large SNR loss as compared with optimal focused beamforming. The near-field conditions here refer to within the Rayleigh distance, and the existing codebook can be a DFT codebook. In addition, when using the low-accuracy phase quantization precoding vector of RIS, the linear phase characteristics of the codewords in the existing codebook (such as DFT codewords) cause the post-quantization phase error to have periodic characteristics, thereby improving the side lobe level of the radiation array or produce grating lobes. For example, when the 1-bit accuracy of RIS is used to quantize the DFT vector, the linear phase characteristics of the DFT codeword cause the post-quantization phase error to have periodic characteristics, thus generating grating lobes.

Therefore, according to one aspect of the present disclosure, it is desired to provide a codebook suitable for determining the focusing matching scheme of RIS based on the Fresnel diffraction principle in dynamic scenes. Furthermore, according to another aspect of the present disclosure, it is expected to improve SNR loss and suppress interference caused by mirror-image grating lobes compared to conventional DFT codebooks.

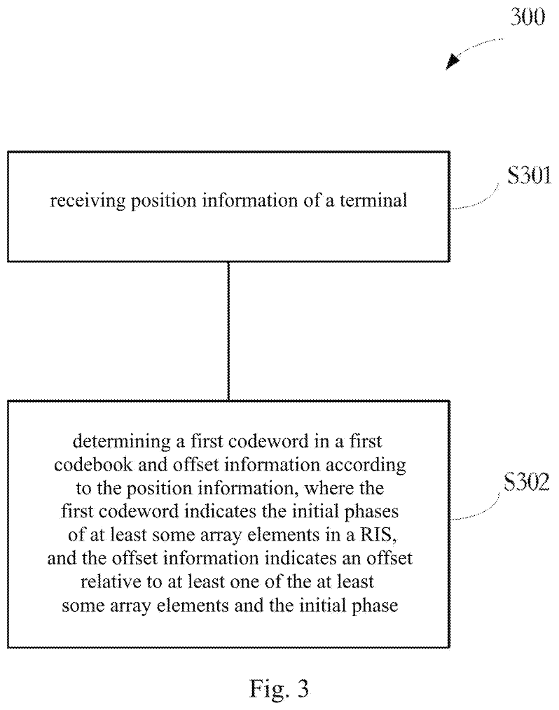

The specific implementation of the codebook structure suitable for RIS of the present disclosure will be described below from the perspective of the sending device and the terminal. First, a method performed by a sending device according to embodiments of the present disclosure is described with reference to FIG. 3. FIG. 3 illustrates a flowchart of method 300 performed by a sending device according to embodiments of the present disclosure. As shown in FIG. 3, in step S301, position information of a terminal is received. According to one example of the present disclosure, the position information of the terminal in step S301 may include information about the position relationship between the RIS and the terminal. In this example, the position information of the terminal may have various representation forms. For example, the position information of the terminal may include information about the distance between the RIS and the terminal and information about the angle of the terminal relative to the RIS.

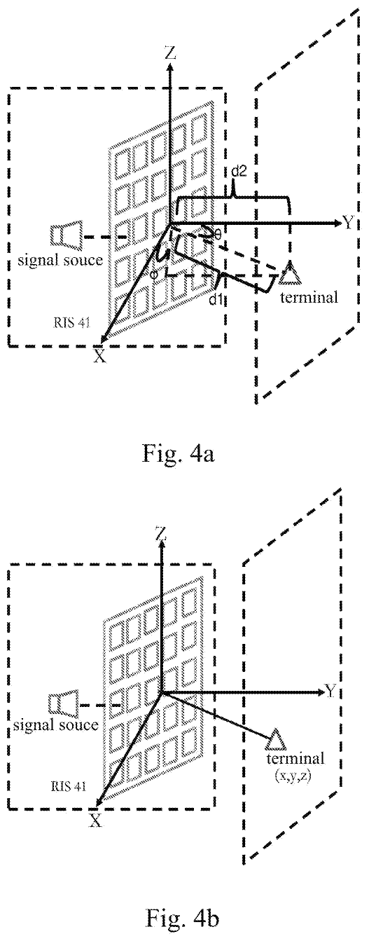

Some representations of position information of the terminal according to embodiments of the present disclosure will be described below with reference to FIGS. 4a and 4b. As shown in FIGS. 4a and 4b, the position information of the terminal may be information about the position relationship between the reference position in the RIS and the terminal. The coordinate system (X, Y, Z) includes the horizontal axis X, the depth axis Y and the vertical axis Z. In FIG. 4a, the position information of the terminal may be the distance information and angle information between the terminal and the center point of RIS 41, RIS 41 is RIS, where d1 represents the distance between the terminal and the center point of RIS 41, and d2 represents the distance between the center of RIS 41 and the focal plane where the terminal is located, θ and ϕ represent the angle of the terminal relative to the center point of RIS 41, where θ is the angle between the projections of d1 on the XOY plane and the YOZ plane, and ϕ is the angle between the projections of d1 on the XOZ plane and the YOZ plane. In FIG. 4b, the position information of the terminal may be the coordinate information of the terminal relative to the center point of RIS 41, and RIS 41 is RIS, where (x, y, z) represents the coordinates of the terminal relative to the center point of RIS 41 is in the coordinate system (X, Y, Z).

It should be recognized that although FIGS. 4a and 4b show two representation forms of position information of the terminal, the present disclosure is not limited thereto. Other representation forms of position information of the terminal also fall within the scope of the present disclosure, such as polar coordinates, etc., without departing from the spirit and scope of the present disclosure.

In this example, the position information of the terminal can be obtained through measurement or calculation. For example, in FIG. 4a, d1, θ, ϕ can be obtained by measurement, while d2 can be obtained by calculating d1, θ, ϕ. This disclosure does not limit the method of obtaining position information of the terminal. In addition, in this example, the position information of the terminal may be the position parameters in FIG. 4a or FIG. 4b. For example, the position information of the terminal may be d1, θ, and ϕ.

Then, in step S302, a first codeword in a first codebook and offset information are determined according to the position information, where the first codeword indicates initial phases of at least some array elements in the RIS, and the offset information indicates an offset relative to at least one of the at least some array elements, the initial phases, and a reference position of the RIS. According to an example of the present disclosure, according to the information about the distance between the RIS and the terminal, the first codeword of the first codebook can be determined, and according to information about the angle between the RIS and the terminal, the offset of the initial phases indicated by the first codeword of the first codebook can be determined or the offset of the radiation array corresponding to the initial phases indicated by the first codeword can be determined.

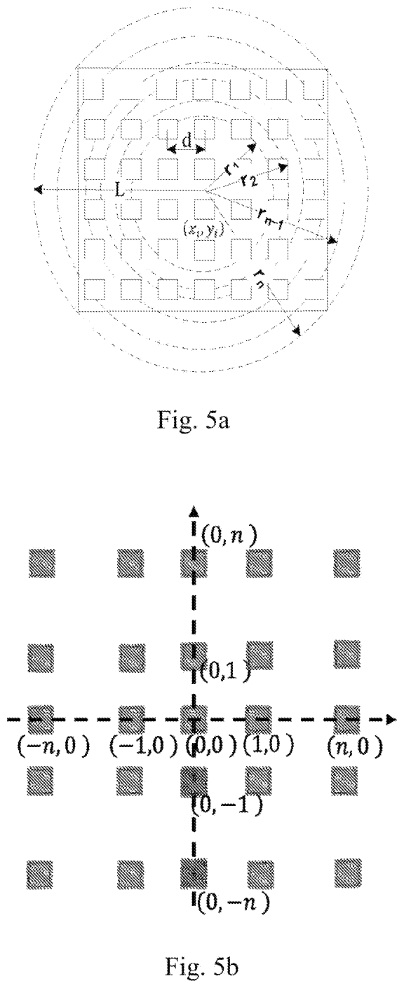

An example of determining the first codeword in the first codebook according to the position information in the embodiment of the present disclosure will be described below with reference to FIGS. 5a and 5b. FIG. 5a shows an example of determining multiple wave band radii R₁, R₂, . . . , R_{N-1}, R_{N} of the RIS used according to position information of the terminal. As shown in FIG. 5a, the mth full wave band of the RIS used can be obtained by formula (1):

$${R}_{m} = \sqrt{{( m λ )}^{2} + 2 mF λ} \qquad formula ( 1 )$$

where Rₘ is the full wave radius, F is d2 in FIG. 4a, λ is the free space wavelength corresponding to the center frequency of the RIS used; m is a positive integer less than or equal to N. If m=N, then the constraint condition R_{N-1}<L<R_{N} is satisfied, where L can be a predetermined length, for example, L can be half the diagonal length of the RIS used.

In FIG. 5a, each wave band can have 8 sub wave bands, and for a specific receiving device, RIS can set a total of 8N sub wave bands. rₙ is the sub wave band radius, rₙ can be determined by Rₘ, and is used to calculate the initial phases of the RIS radiation array element in the sub wave band. rₙ can be obtained by formula (2):

$${r}_{n} = \sqrt{{( \frac{n λ}{8} )}^{2} + \frac{2 nF λ}{8}} , n = 1 , 2 , ... , 8 N \qquad formula ( 2 )$$

The sub wave band range can be obtained by formula (3) and formula (4):

$$0 < \sqrt{{{x}_{i}}^{2} + {{y}_{i}}^{2}} < \frac{{r}_{1}}{d} ⇒ \frac{π}{4} \qquad formula ( 3 )$$

$$\frac{{r}_{n - 1}}{d} = \sqrt{{{x}_{i}}^{2} + {{y}_{i}}^{2}} < \frac{{r}_{n}}{d} ⇒ n \frac{π}{4} , n = 2 , 3 , ... , 8 N \qquad formula ( 4 )$$

where d is the spacing between the radiation array elements of the RIS used, xᵢ and yᵢ are the coordinates of the radiation array element of the RIS used. The coordinates of the radiation array element are defined as shown in FIG. 5b. In this example, the initial phases of the corresponding radiation array element in the used RIS can be configured per sub wave band, thereby obtaining the first codeword of the first codebook of the used RIS.

As mentioned above, the RIS radiation array elements used in the odd-numbered wavebands can be phase-shifted by 0° to increase the field strength, and the RIS radiation array elements used in the even-numbered wavebands can be phase-shifted by 180° to reduce the field strength. In this example, r₁, r₂, . . . , rₙ₋₁, rₙ can be determined based on the position information of the terminal described above, for example, r₁, r₂, . . . , rₙ₋₁, rₙ can be determined according to d1, θ, and ϕ in FIG. 4a, or it can also be determined according to d2 in FIG. 4a.

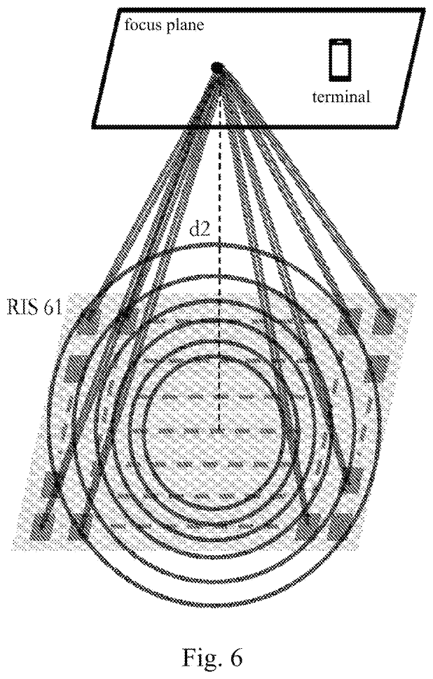

According to an example of the present disclosure, the first codeword in the first codebook in step S302 may cause the RIS to form a focused beam focused on the focal plane where the terminal is located under near-field conditions. The focused beam formed according to the first codeword of the first codebook in the embodiment of the present disclosure will be described below with reference to FIG. 6. As shown in FIG. 6, the terminal is located in the area above RIS 61. The RIS 61 can be a part used in the entire RIS. The first codeword of the first codebook can be used to form a focused beam focused on the focal plane where the terminal is located, the focal length between the center point of the RIS 61 and the focal plane where the terminal is located is d2 as described according to the present disclosure. In this example, there is a certain offset distance between the focus of the focused beam formed by the first codeword of the first codebook of the RIS 61 and the terminal on the focal plane.

In the above example, the offset information may be determined based on position information of the terminal. In this example, the offset information may indicate an offset relative to at least one of at least a portion of the array elements, initial phases, and a reference position of the RIS. For example, the offset information may indicate the phase offset of the initial phases of the array element indicated by the first codeword, so that the beams transmitted by each wave band area in the RIS are focused on the position of the receiving device. For another example, the offset information may indicate the translation distance of at least some of the array elements in the RIS, so that the beams emitted by each translated waveband area can be focused on the position of the receiving device. As another example, the offset information may indicate an offset between a logical RIS area and an actual RIS device.

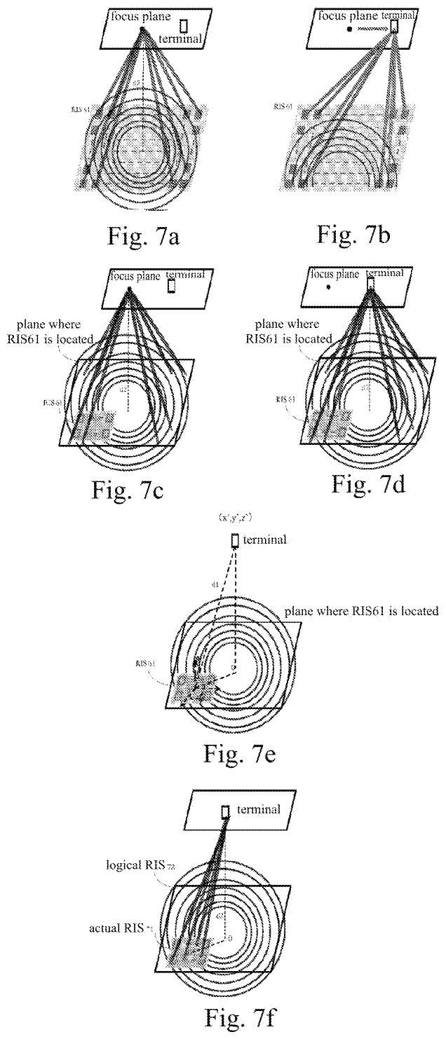

Determining the phase offset indicating the initial phases of the array element indicated by the first codeword according to the position information in the embodiment of the present disclosure will be described below with reference to FIG. 7a and FIG. 7b. An example of determining offset information indicating the translation distance of at least some array elements according to the position information in the embodiment of the present disclosure will be described with reference to FIGS. 7c, 7d, and 7e. Determining the offset relative to the reference position of the RIS according to the position information in the embodiment of the present disclosure will be described with reference to FIG. 7f.

According to one example of the present disclosure, the offset information in step S302 may indicate an offset relative to initial phases of the used RIS, which is indicated by the first codeword of the first codebook. The offset information may be used to form a transmission beam that deflects the focused beam formed according to the first codeword of the first codebook to the terminal. As shown in FIG. 7a, the first codeword of the first codebook of RIS 61 can form a focused beam focused on the focal plane where the terminal is located, and as shown in FIG. 7b, the offset information can deflect the focused beam to the terminal. phase offset information. The phase offset information can be superimposed on the initial phases of the RIS 61 indicated by the first codeword of the first codebook, thereby forming a transmission beam focused on the terminal. In this example, the position information of the terminal may be the position parameters in FIG. 4a or FIG. 4b. For example, the position information of the terminal may be θ and ϕ.

According to another example of the present disclosure, the offset information in step S302 may indicate an offset relative to at least some array elements of the RIS, and at least some array elements of the RIS may be the RIS used according to the present disclosure, for example RIS 61 in FIG. 6. In this example, the first codeword of the first codebook in step S302 may indicate the initial phases of the plane where at least some array elements of the RIS are located. In this example, as shown in FIG. 7c, the first codeword of the first codebook of the plane where at least some array elements of the RIS are located can form a focused beam focused on the focal plane where the terminal is located. In this example, the plane where at least some array elements of the RIS are located can be offset according to the position information of the terminal, so that the first codeword of the first codebook of the plane where at least some array elements of the RIS is located can form a focused beam focused on the terminal, as shown in FIG. 7d. Then, the phase information of corresponding array elements in at least some array elements of the RIS can be determined from the first codeword of the first codebook as the second codeword of the second codebook, thereby forming a transmission beam focused on the terminal. For example, as shown in FIG. 7d, the phase information of the RIS 61 can be determined from the first codeword of the first codebook as the second codeword of the second codebook. In this example, the offset information may indicate the offset of at least some array elements of the RIS. In this example, the position information of the terminal may be the position parameters in FIG. 4a or FIG. 4b. For example, the position information of the terminal may be θ and ϕ. In this example, some array elements used in the RIS can be adjusted according to different actual positions of the terminal, which improves the flexibility of the wireless communication system.

According to the above embodiments of the present disclosure, by combining the first codeword and offset information of the first codebook based on the Fresnel diffraction principle, the focusing of the RIS at any point within the near-field radiation range can be achieved, thereby improving the SNR for the near-field radiation range of the radiation array. In addition, the phase distribution of the first codeword of the first codebook based on the Fresnel diffraction principle avoids periodic quantization noise caused by low phase shift accuracy, thereby suppressing the generation of grating lobes of the radiation array and reducing electromagnetic signal leakage caused by the grating lobes and side lobes of the radiation array.

According to another example of the present disclosure, the position information includes information about a distance between the RIS and the terminal, and information about an angle of the terminal relative to the RIS. Method 300 further includes: determining the radii of multiple wave bands generated by the RIS based on the information about the distance, and determining the first codeword based on the determined radii; and determining the offset information based on the information about the angle. In this example, the information about the distance can be d1, θ, ϕ in FIG. 4a, or it can be d2 in FIG. 4a. An example of determining the radii of multiple wave bands of the RIS and their corresponding first codewords based on the information about the distance has been described in this disclosure in conjunction with FIG. 5 and will not be described again here.

An example of determining offset information based on information about angles in the embodiment of the present disclosure will be described below with reference to FIG. 7e. As shown in FIG. 7e, the information about the angle can be θ and ϕ in FIG. 4a, O is the center point of the plane where RIS 61 is located, O′ is the center point of RIS 61, and the coordinate information of O′ relative to O can be recorded as (l₁, l₂), then l₁ and l₂ can be obtained through formula (5) and formula (6):

$${l}_{1} = d 1 sin θcosφ \qquad formula ( 5 )$$

$${l}_{2} = d 1 sin θsinφ \qquad formula ( 6 )$$

According to the coordinate information (l₁, l₂), the phase distribution corresponding to the position of RIS 61 in the plane where RIS 61 is located is determined from the first codeword of the first codebook, and then the phase distribution used to form a sending beam focused on the terminal is obtained. In another example, as shown in FIG. 7e, the information about the angle may be the coordinate information (x′, y′, z′) of the terminal relative to O′, O is the center point of the plane where the RIS 61 is located, and O′ is the center point of RIS 61. The coordinate information of O′ relative to O can be recorded as (l₁, l₂), then l₁ and l₂ can be obtained through formula (7) and formula (8):

$${l}_{1} = {x}^{′} \qquad formula ( 7 )$$

$${l}_{2} = {y}^{′} \qquad formula ( 8 )$$

According to the coordinate information (l₁, l₂), the phase distribution corresponding to the position of RIS 61 in the plane where RIS 61 is located is determined from the first codeword of the first codebook, and then the phase distribution used to form a sending beam focused on the terminal is obtained.

According to another example of the present disclosure, the offset information includes a second codeword in a second codebook. In this example, the second codebook may be a codebook used in codebook-based precoding technology. In one example, the second codebook is a discrete Fourier transform (DFT) codebook. In this example, the two-dimensional DFT matrix of the DFT codebook is shown in formula (9):

$$\begin{matrix}T ( 0 , 0 ) & ... & T ( 0 , N - 1 ) \\ ... & ... & ... \\ T ( M - 1 , 0 ) & ... & T ( M - 1 , N - 1 )\end{matrix} \qquad formula ( 9 )$$

where

$$T ( k , j ) = {e}^{- j 2 π ( \frac{ux}{M} + \frac{vy}{N} )} ,$$

u=0, . . . , M−1, ν=0, . . . , N−1. In this example, the offset information indicates an offset relative to the initial phases. In this example, the DFT codebook in the Type I codebook or the Type II codebook in Release 15 or Release 16 of 5G NR can be used for beam steering. In this example, the solution of the two-level structure of the first codebook and the DFT codebook according to the present disclosure is adopted to enhance the existing DFT codebook, making it easy to combine with the current solution.

According to another example of the present disclosure, the offset information includes an offset relative to at least a portion of the array elements. The present disclosure has described the offset information relative to the offset of at least some radiation array elements in conjunction with FIG. 7e, and will not be described again here.

The offset information may indicate the offset between the logical RIS area and the actual RIS device in conjunction with FIG. 7f below. In the example shown in FIG. 7f, RIS 72 is a logic RIS capable of sending focus to the terminal. The phase distribution of the logic RIS 72 can be configured per sub wave band according to the above method to obtain the first codeword. The logical RIS 72 is located in the same plane as the actual RIS 71. As shown in FIG. 7f, the distance from the center point of the logical RIS 72 to the terminal is d2.

In the example shown in FIG. 7f, the phase of the actual RIS 71 can be obtained from the phase of the logical RIS 72 based on the position information of the terminal. For example, the offset of the reference position of the actual RIS 71 relative to the reference position of the logical RIS 72 may be determined based on position information of the terminal. As shown in FIG. 7f, the center point of the actual RIS 71 is O′, and the center point of the logical RIS 72 is O. Let the coordinate information of O′ relative to O be (l₁, l₂), then l₁ and l₂ can be obtained by the above formula (5) and formula (6). For example, l₁ and l₂ can be obtained by the above formula (7) and formula (8). According to the coordinate information (l₁, l₂), the phase corresponding to the position of the actual RIS 71 is determined from the phase of the logical RIS 72, and then the phase used by the actual RIS 71 to form a sending beam focused on the terminal is obtained.

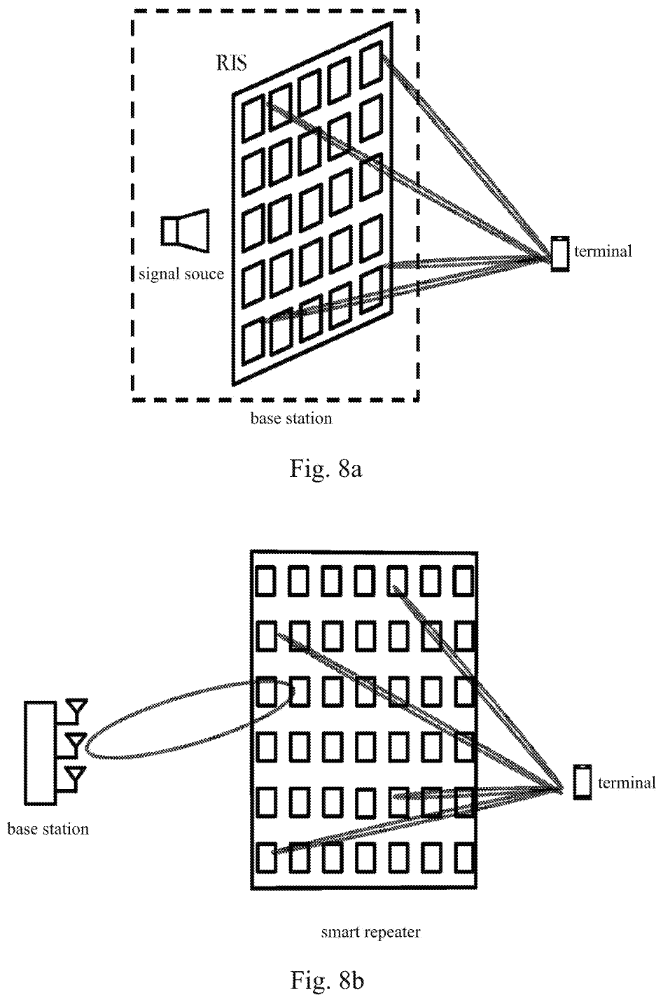

According to another example of the present disclosure, the sending device is a base station in a communication system, and the base station includes an RIS. A wireless communication system for deploying an RIS according to embodiments of the present disclosure is described below with reference to FIG. 8a. As shown in FIG. 8a, RIS can be deployed on the base station and used as a large-scale antenna for the base station. In this example, method 300 may be performed on a base station.

According to an example of the present disclosure, the sending device is a Smart Repeater in the communication system, and the Smart Repeater includes a RIS. A wireless communication system for deploying an RIS according to embodiments of the present disclosure is described below in conjunction with FIG. 8b. As shown in FIG. 8b, RIS can be deployed on a Smart Repeater (SR), using RIS as an intelligent reflective surface on the SR. In this example, method 300 may be performed on a Smart Repeater. In this example, the RIS can be set in the corresponding device in the wireless communication system according to actual deployment needs, which improves the flexibility of the system.

Through the method executed by the sending device in the above embodiments of the present disclosure, codebook design suitable for RIS can be effectively performed, which can improve the SNR of the near-field radiation range of the radiation array and reduce the electromagnetic signal leakage caused by the grating lobes and side lobes of the radiation array, thereby improving the performance of the communication system. In this example, the RIS can be set in the corresponding device in the wireless communication system according to actual deployment needs, which improves the flexibility of the system.

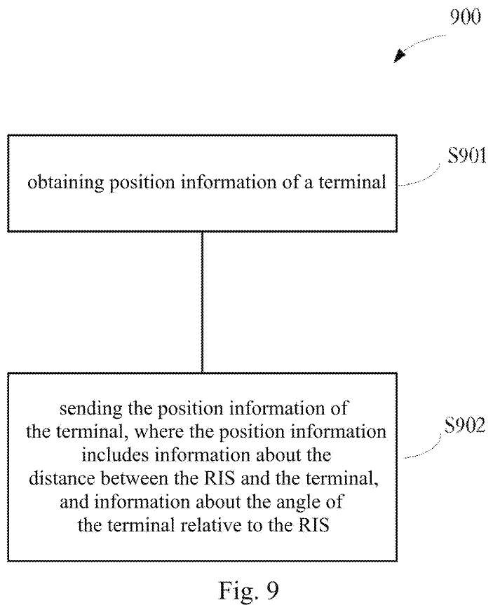

Next, a method performed by a terminal according to embodiments of the present disclosure is described with reference to FIG. 9. FIG. 9 shows a flowchart of a method performed by a base station according to embodiments of the present disclosure. Since the method 900 is identical in certain details to the method 300 described above with reference to FIG. 3, a detailed description of the same content is omitted for simplicity.

As shown in FIG. 9, in step S901, position information of a terminal is obtained. In step S902, the position information of the terminal is sent, where the position information includes information about the distance between the RIS and the terminal, and information about the angle of the terminal relative to the RIS.

According to an example of the present disclosure, the present disclosure has explained the position information of the terminal in conjunction with FIG. 5, which will not be described again here.

According to another example of the present disclosure, the method 900 further includes sending a distance indication or a near-field condition indication to a sending device, wherein the distance indication or the near-field condition indication includes the position information. In this example, the terminal can measure based on the reference signal (RS) sent by the sending device, and feedback positioning-related measurement information or position information (such as information about the distance between the RIS and the terminal and information about the angle of the terminal relative to the RIS).

According to another example of the present disclosure, the terminal can measure the channel state information reference signal (CSI-RS) sent by the sending device, determine the channel condition based on the measurement results, and determine the precoding matrix indicator (Precoding Matrix Indicator (PMI). The terminal can include PMI in the CSI report and send the CSI report to the sending device, thereby realizing feedback of PMI to the sending device. In this example, in addition to feeding back CSI (including CSI of the Type I codebook or Type II codebook in Release 15 or Release 16 of 5G NR), the PMI can also feedback a near-field condition indication that is related to the distance from the terminal to the sending device.

According to another example of the present disclosure, the method 900 further includes: obtaining the position information based on a channel state information reference signal or a positioning reference signal. In this example, the terminal may feedback positioning-related measurement information or position information (such as information about the distance between the RIS and the terminal and information about the angle of the terminal relative to the RIS) based on CSI-RS or Positioning Reference Signal (PRS). Information).

Through the method executed by the terminal in the above embodiments of the present disclosure, the codebook design suitable for RIS can be effectively carried out, which can improve the SNR of the near-field radiation range of the radiation array and reduce the leakage of electromagnetic signals caused by the grating lobes and side lobes of the radiation array, thereby improving the performance of the communication system.

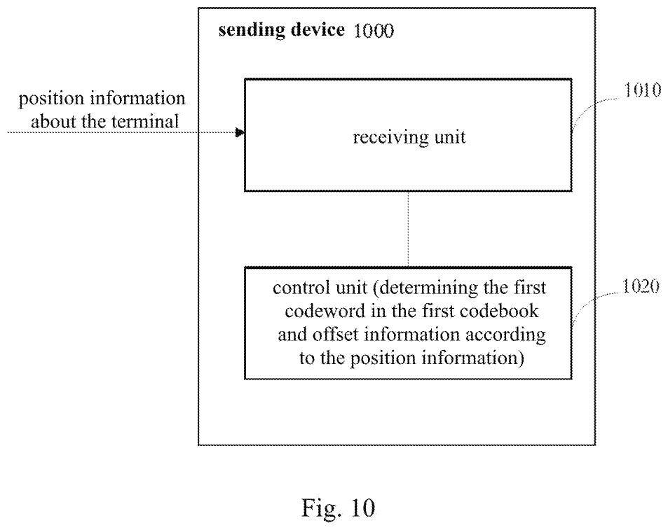

Next, a sending device according to embodiments of the present disclosure is described with reference to FIG. 10. FIG. 10 is a schematic structural diagram of a sending device according to embodiments of the present disclosure. Since the functionality of the sending device is the same as certain details of the method 300 described above with reference to FIG. 3, a detailed description of the same content is omitted for simplicity. As shown in FIG. 10, the sending device 1000 includes: a receiving unit 1010 configured to receive position information of the terminal; and a control unit 1020 configured to determine the first codeword in the first codebook and and offset information according to the position information, where the first codeword indicates initial phases of at least some array elements in the RIS, and the offset information indicates offset relative to at least one of the at least some array elements, the initial phases, and a reference position of the RIS.

According to an example of the present disclosure, the position information includes information about the distance between the RIS and the terminal, and information about the angle of the terminal relative to the RIS; the control unit is further configured to determine radii of a plurality of wave bands generated by the RIS based on information about distance, and determine the first codeword based on the determined radii; and the control unit is further configured to determine the offset information based on information about angles.

According to an example of the present disclosure, the offset information includes a second codeword in a second codebook.

According to an example of the present disclosure, the second codebook is a DFT codebook, and the offset information indicates an offset relative to the initial phases.

According to an example of the present disclosure, the offset information includes an offset relative to at least some array elements.

According to an example of the present disclosure, the sending device is a base station in the communication system, and the base station includes the RIS.

According to an example of the present disclosure, the sending device is an Smart Repeater in the communication system, and the Smart Repeater includes the RIS.

Through the sending device of the above embodiments of the present disclosure, the codebook design suitable for RIS can be effectively carried out, which can improve the SNR of the near-field radiation range of the radiation array, reduce the electromagnetic signal leakage caused by the grating lobes and side lobes of the radiation array, thereby improving Communication system performance.

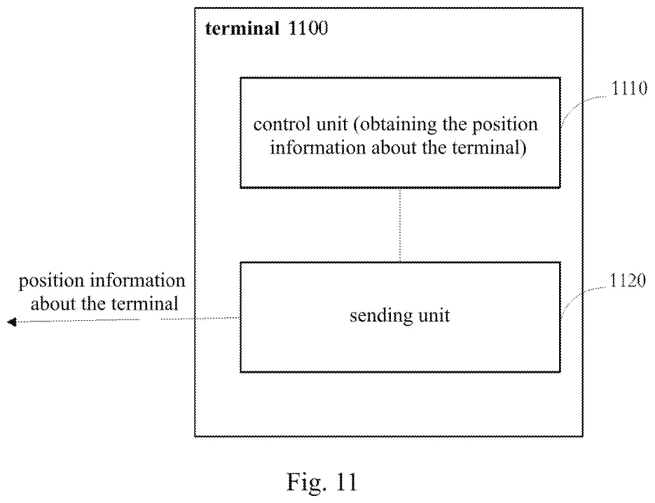

Next, a terminal according to embodiments of the present disclosure is described with reference to FIG. 11. FIG. 11 is a schematic structural diagram of a terminal according to embodiments of the present disclosure. Since the functions of the terminal are the same as certain details of the method 900 described above with reference to FIG. 9, a detailed description of the same content is omitted for simplicity. As shown in FIG. 11, the terminal 1100 includes: a control unit 1110 to obtain position information of the terminal; and a sending unit 1120 to transmit the position information of the terminal, where the position information includes information about the distance between the two terminals, and information about the angle of the terminal relative to the RIS.

According to an example of the present disclosure, the sending unit is further configured to transmit a distance indication or a near-field condition indication to a sending device, wherein the distance indication or the near-field condition indication includes the position information.

According to an example of the present disclosure, the control unit is further configured to obtain the position information based on a channel state information reference signal or a positioning reference signal.

Through the terminals of the above embodiments of the present disclosure, codebook design suitable for RIS can be effectively carried out, which can improve the SNR of the near-field radiation range of the radiation array and reduce the electromagnetic signal leakage caused by the grating lobes and side lobes of the radiation array, thereby improving performance of the communications system.

### <Hardware Structure>

In addition, the block diagrams used in the description of the above embodiments show blocks in units of functions. These functional blocks (structural units) are implemented by any combination of hardware and/or software. In addition, the means for realizing each functional block is not particularly limited. That is, each functional block may be implemented by one device that is physically and/or logically combined, or two or more devices that are physically and/or logically separated may be implemented directly and/or indirectly (For example, through wired and/or wireless connection, the above-mentioned multiple devices are implemented.

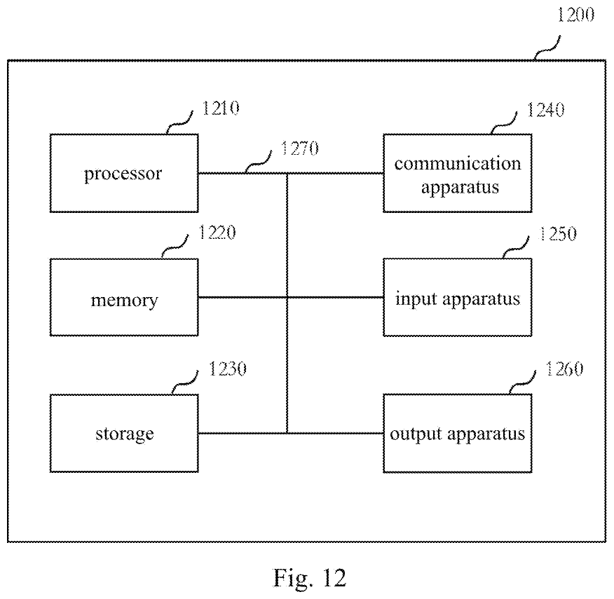

For example, a communication device (such as a terminal, a base station, an RIS, or a Smart Repeater) according to embodiments of the present disclosure may function as a computer that performs the processing of the wireless communication method of the present disclosure. FIG. 12 is a schematic diagram of the hardware structure of the communication device 1200 (terminal or base station) involved according to embodiments of the present disclosure. The communication device 1200 described above may be configured as a computer device physically including a processor 1210, a memory 1220, a storage 1230, a communication device 1240, an input device 1250, an output device 1260, a bus 1270, and the like.

In addition, in the following description, the word “apparatus” may be replaced by a circuit, a device, a unit, etc. The hardware structure of the user terminal and the base station may include one or more of the devices shown in the figure, or may not include some devices.

For example, only one processor 1210 is shown in the figure, but it may also be multiple processors. In addition, the processing may be performed by one processor, or may be performed by more than one processor simultaneously, sequentially, or using other methods. Additionally, processor 1210 may be implemented on more than one chip.

Each function of the device 1200 is realized, for example, by reading predetermined software (program) into hardware such as the processor 1210 and the memory 1220, causing the processor 1210 to perform calculations, controlling communication by the communication device 1240, and controlling the reading and/or writing of data in the memory 1220 and the storage 1230.

The processor 1210 controls the entire computer by operating an operating system, for example. The processor 1210 may be composed of a central processing unit (CPU) including an interface with peripheral devices, a control device, an arithmetic device, a register, and the like. For example, the above-mentioned determination unit, adjustment unit, etc. can be implemented by the processor 1210.

In addition, the processor 1210 reads out programs (program codes), software modules, data, etc. from the storage 1230 and/or the communication device 1240 to the memory 1220, and performs various processes based on them. As the program, a program that causes the computer to execute the operations described in the above embodiments can be used. For example, the control unit of the terminal 500 can be implemented by a control program stored in the memory 1220 and operated by the processor 1210. Other functional blocks can also be implemented in the same way.

The memory 1220 is a computer-readable recording medium, which can be composed of at least one of, for example, a read-only memory (ROM), a programmable read-only memory (EPROM), an electrically programmable read-only memory (EEPROM), random access memory (RAM) and other appropriate storage media. The memory 1220 may also be called a register, a cache, a main memory (main storage device), or the like. The memory 1220 can store executable programs (program codes), software modules, etc. for implementing the method according to embodiments of the present disclosure.

The storage 1230 is a computer-readable recording medium, and may be composed of, for example, a flexible disk, a floppy (Registered Trademark) disk, a magneto-optical disk (for example, a CD-ROM (Compact Disc ROM), etc.), Digital Versatile Disc, Blu-ray (Registered Trademark) Disc), removable disk, hard drive, smart card, flash memory device (e.g., card, stick, key driver), magnetic stripe, database, a server, and other appropriate storage media. Storage 1230 may also be referred to as a secondary storage device.

The communication device 1240 is hardware (sending and receiving device) used for communication between computers through a wired and/or wireless network, and is also called, for example, a network device, a network controller, a network card, a communication module, etc. In order to implement, for example, Frequency Division Duplex (FDD) and/or Time Division Duplex (TDD), the communication device 1240 may include a high-frequency switch, a duplexer, a filter, a frequency synthesizer, etc. For example, the above-mentioned sending unit, receiving unit, etc. of the terminal 500 can be implemented by the communication device 1240.

The input device 1250 is an input device (eg, keyboard, mouse, microphone, switch, button, sensor, etc.) that accepts input from the outside. The output device 1260 is an output device (for example, a display, a speaker, a light emitting diode (LED, Light Emitting Diode) lamp, etc.) that performs output to the outside. In addition, the input device 1250 and the output device 1260 may also have an integrated structure (such as a touch panel).

In addition, each device such as the processor 1210 and the memory 1220 is connected through a bus 1270 for communicating information. The bus 1270 may be composed of a single bus or different buses between devices.

In addition, base stations and terminals may include microprocessors, digital signal processors (DSPs), application specific integrated circuits (ASICs), programmable logic devices (PLDs), Field Programmable Gate Arrays (FPGAs) and other hardware that can realize part or all of each functional block through this hardware. For example, processor 1210 may be installed with at least one of these pieces of hardware.

### (Modification)

In addition, terms described in this specification and/or terms required for understanding this specification may be interchanged with terms having the same or similar meaning. For example, channels and/or symbols can also be signals (signaling). In addition, signals can also be messages. The reference signal can also be called RS (Reference Signal) for short. Depending on the applicable standard, it can also be called pilot, pilot signal, etc. In addition, a component carrier (CC) may also be called a cell, a frequency carrier, a carrier frequency, etc.

In addition, the information, parameters, etc. described in this specification may be expressed as absolute values, relative values to prescribed values, or other corresponding information. For example, a radio resource may be indicated by a specified index. Furthermore, the formulas and the like using these parameters may also be different from those explicitly disclosed in this specification.

The names used for parameters and the like in this specification are not limiting in any way. For example, various channels (Physical Uplink Control Channel (PUCCH), Physical Downlink Control Channel (PDCCH), etc.) and information units can be identified by any appropriate name, and therefore the various names assigned to these various channels and information units are not limiting in any way.

The information, signals, etc. described in this specification may be represented using any of a variety of different technologies. For example, the data, commands, instructions, information, signals, bits, symbols, chips, etc. that may be mentioned in all the above descriptions may be expressed by voltages, currents, electromagnetic waves, magnetic fields or magnetic particles, light fields or photons, or any combination thereof.

In addition, information, signals, etc. may be output from an upper layer to a lower layer and/or from a lower layer to an upper layer. Information, signals, etc. can be input or output via multiple network nodes.

Input or output information, signals, etc. can be stored in a specific place (such as memory) or managed through a management table. Input or output information, signals, etc. can be overwritten, updated or supplemented. Output information, signals, etc. can be deleted. Input information, signals, etc. can be sent to other devices.

Notification of information is not limited to the methods/implementations described in this specification, and can also be performed through other methods. For example, the information may be notified through physical layer signaling (for example, Downlink Control Information (DCI), Uplink Control Information (UCI)), upper layer signaling (for example, Radio Resource Control (RRC) signaling, broadcast information (Master Information Block (MIB), System Information Block (SIB), etc.), Media Access Control (MAC) signaling), other signals, or combination thereof.

In addition, physical layer signaling may also be called L1/L2 (layer 1/layer 2) control information (L1/L2 control signal), L1 control information (L1 control signal), etc. In addition, RRC signaling may also be called an RRC message, and may be, for example, an RRC Connection Setup message, an RRC Connection Reconfiguration message, or the like. In addition, MAC signaling may be notified through a MAC Control Element (MAC CE), for example.

In addition, the notification of specified information (for example, the notification of “is X” is not limited to being performed explicitly, and can be implicitly (for example, by not performing the notification of the specified information or by notification of other information) performed.

Judgment can be performed using a value represented by 1 bit (0 or 1), a true or false value (Boolean value) represented by true or false, or a comparison of numerical values (for example, comparison with a specified value).

Software, whether called software, firmware, middleware, microcode, hardware description language, or by any other name, shall be construed broadly to mean commands, command sets, code, code segments, program code, programs, subprograms, software module, application, software application, software package, routine, subroutine, object, executable file, thread of execution, step, function, etc.

Additionally, software, commands, information, etc. may be sent or received via transmission media. For example, when using wired technology (coaxial cable, optical cable, twisted pair, Digital Subscriber Line (DSL), etc.) and/or wireless technology (infrared, microwave, etc.) to send from a website, server, or other remote resource When using software, these wired and/or wireless technologies are included in the definition of transmission media.

The terms “system” and “network” used in this specification are used interchangeably.

In this specification, terms such as “base station (BS)”, “wireless base station”, “eNB”, “gNB”, “cell”, “sector”, “cell group”, “carrier” and “component carrier” can be used interchangeably. A base station is sometimes also called a fixed station, NodeB, eNodeB (eNB), access point, transmitting point, receiving point, femtocell, small cell, etc.

A base station can house one or more (for example, three) cells (also called sectors). When a base station accommodates multiple cells, the entire coverage area of the base station can be divided into multiple smaller areas, and each smaller area can provide communication services through the base station subsystem (for example, indoor small base station (Remote Radio Head (RRH))). The terms “cell” or “sector” refer to a portion or the entire coverage area of a base station and/or base station subsystem that provides communication services within that coverage.

In this specification, the terms “Mobile Station (MS)”, “User Terminal”, “User Equipment (UE)” and “Terminal” are used interchangeably. A mobile station is sometimes referred to by those skilled in the art as a subscriber station, mobile unit, subscriber unit, wireless unit, remote unit, mobile device, wireless device, wireless communications device, remote device, mobile subscriber station, access terminal, mobile terminal, wireless Terminal, remote terminal, handset, user agent, mobile client, client or any other suitable term.

In addition, the base station in this specification can also be replaced by a terminal. For example, various modes/implementations of the present disclosure may also be applied to a structure in which communication between a base station and a terminal is replaced by communication between multiple terminals (D2D, Device-to-Device). At this time, the functions of the base station 600 can be regarded as the functions of the terminal. In addition, words such as “upline” and “downline” can also be replaced with “side”. For example, the uplink channel can also be replaced by a side channel.

Similarly, the terminals in this specification can also be replaced by base stations. At this time, the above-mentioned functions of the terminal 500 can be regarded as functions of the base station.

In this specification, it is assumed that a specific operation performed by a base station may also be performed by its upper node in some cases. Obviously, in a network composed of one or more network nodes with a base station, various actions performed for communication with terminals can be performed through the base station or one or more network nodes other than the base station (for example, Mobility Management Entity (MME), Serving-Gateway (S-GW), etc. may be considered, but are not limited thereto), or a combination thereof.

Each of the methods/implementations described in this specification can be used individually or in combination, or can be used by switching during execution. In addition, the processing steps, sequences, flowcharts, etc. of each mode/implementation described in this specification may be reordered as long as there is no contradiction. For example, regarding the method described in this specification, various step units are given in an exemplary order and are not limited to the specific order given.

Each method/implementation described in this specification can be applied to utilize Long Term Evolution (LTE, Long Term Evolution), Long Term Evolution Advanced (LTE-A, LTE-Advanced), Long Term Evolution Beyond (LTE-B, LTE-Beyond), Super 3rd generation mobile communication system (SUPER 3G), advanced international mobile telecommunication (IMT-Advanced), 4th generation mobile communication system (4G), 5th generation mobile communication system (5G), 6th generation mobile communication system (6G), Future Radio Access (FRA), New-RAT (Radio Access Technology), New Radio (NR), New radio access (NX), Future generation radio access (FX), Global System for Mobile communications (GSM (registered trademark), Global System for Mobile communications), Code Division Multiple Access 3000 (CDMA3000), Ultra Mobile Broadband (UMB), IEEE 920.11 (Wi-Fi (registered trademark)), IEEE 920.16 (WiMAX (registered trademark)), IEEE 920.20, Ultra-WideBand (UWB), Bluetooth (registered trademark), other appropriate wireless communication method systems and/or next-generation systems expanded based on them.

The expression “based on” used in this specification does not mean “only based on” unless it is explicitly stated in other paragraphs. In other words, the description “based on” means both “only based on” and “based on at least”.

Any reference used in this specification to units using names such as “first”, “second”, etc. is not intended to comprehensively limit the number or order of these units. These names may be used in this specification as a convenient way of distinguishing two or more units. Thus, reference to a first unit and a second unit does not mean that only two units may be employed or that the first unit must precede the second unit in some form.

The term “determining” used in this specification may include various actions. For example, regarding “determining”, calculating, calculating, processing, deriving, investigating, looking up (such as Searching in tables, databases, or other data structures), ascertaining, etc. are regarded as “determining”. In addition, regarding “determining”, it is also possible to refer to receiving (for example, receiving information), transmitting (for example, transmitting information), input, output, and accessing (for example, accessing data in memory), etc. are regarded as “determining”. In addition, regarding “determining”, resolving, selecting, choosing, establishing, comparing, etc. can also be regarded as performing “determining”. That is to say, regarding “determining”, several actions can be regarded as performing “determining”.

The terms “connected”, “coupled” or any variations thereof used in this specification refer to any direct or indirect connection or combination between two or more units, including the following situations: there are one or more intermediate units between two units that are “connected” or “combined” with each other. The combination or connection between units can be physical, logical, or a combination of both. For example, “connection” can also be replaced by “access”. As used in this specification, two units may be considered to be connected through the use of one or more wires, cables, and/or printed electrical connections, and, by way of several non-limiting and non-exhaustive examples, through the use of radio frequency areas, microwave region, and/or electromagnetic energy with wavelengths in the light (both visible light and invisible light) region, are “connected” or “combined” with each other.

When “including”, “comprising” and their variations are used in this specification or claims, these terms are as open-ended as the term “having”. Furthermore, the word “or” used in this specification or the claims does not mean exclusive-OR.

The present disclosure has been described in detail above. However, it is obvious to those skilled in the art that the present disclosure is not limited to the embodiments described in this specification. The present disclosure can be implemented with modifications and changes without departing from the spirit and scope of the present disclosure determined by the recitation of the claims. Therefore, the description in this specification is for the purpose of illustration and does not have any restrictive meaning on the present disclosure.

1. A sending device in a communication system, comprising:
a receiving unit configured to receive position information of a terminal; and
a control unit configured to determine a first codeword in a first codebook and offset information according to the position information, wherein the first codeword indicates initial phases of at least some array elements of a Reconfigurable Intelligent Surface (RIS), and the offset information indicates an offset relative to at least one of the at least some array element, the initial phases, and a reference position of the RIS.

2. The sending device of claim 1, wherein
the position information includes information about a distance between the RIS and the terminal, and information about an angle of the terminal relative to the RIS;
the control unit is further configured to determine radii of a plurality of wave bands generated by the RIS based on the information about the distance, and determine the first codeword based on the determined radii; and
the control unit is further configured to determine the offset information based on the information about the angle.

3. The sending device of claim 1, wherein the offset information includes a second codeword in a second codebook.

4. The sending device of claim 3, wherein,
the second codebook is a Discrete Fourier Transform (DFT) codebook, and
the offset information indicates an offset relative to the initial phases.

5. The sending device of claim 1, wherein the offset information includes an offset relative to at least some array elements.

6. The sending device of claim 1, wherein the sending device is a base station in the communication system, and the base station includes the RIS.

7. The sending device of claim 1, wherein the sending device is a Smart Repeater in the communication system, and the Smart Repeater includes the RIS.

8. A terminal in a communication system, including:
a control unit to obtain position information of the terminal; and
a sending unit to send the position information of the terminal, wherein the position information includes information about a distance between a Reconfigurable Intelligent Surface (RIS) and the terminal, and information about an angle of the terminal relative to the terminal.

9. The terminal of claim 8, wherein the sending unit is further configured to send a distance indication or a near-field condition indication to a sending device, wherein the distance indication or the near-field condition indication includes the position information.

10. The terminal of claim 8, wherein the control unit is further configured to obtain the position information based on a channel state information reference signal or a positioning reference signal.
